(19) United States
(12) Patent Application Publication
(10) Pub. No.: US 2020/0164232 A1
(43) Pub. Date: May 28, 2020

(54) BELAY DEVICE

(71) Applicant: ZEDEL, Crolles (FR)

(72) Inventors: Olivier MATHE, Taninges (FR); Christophe QUILLARD, Eybens (FR)

(73) Assignee: ZEDEL, Crolles (FR)

(21) Appl. No.: 16/699,392

(22) Filed: Nov. 29, 2019

(30) Foreign Application Priority Data
Nov. 28, 2018 (FR) 1872028

(51) Int. Cl. A62B 1/14

(52) U.S. Cl. CPC A62B 1/14

(57) ABSTRACT

The belay device comprises:
a body with an inlet for insertion of a strand of rope forming a loop,
a shaft and clamping part mounted on the body, the shaft extending in a longitudinal direction,
an attachment opening collaborating with a carabiner connecting the belay device with a harness,
a cam with a first end mounted in rotation on the shaft along a path so as to move towards or away from the clamping part and to define a first clamping position of the rope and another position.

The cam, body and clamping part define a running path of the rope. The rope strand passes between the cam and the clamping part. The first end defines a through opening formed by the attachment opening. The connecting part is fitted movable in rotation with respect to the body along the path.

### BACKGROUND OF THE INVENTION

The invention relates to a belay device for a rope for rock climbing or mountaineering and more generally for activities performed at height.

### PRIOR ART

In numerous activities relating to activities at height such as rock climbing or mountaineering, it is necessary to use a belay device that collaborates with a rope to define a clamping position of the rope and a controlled running position of the rope.

Different belay device architectures have been developed in the course of time. These architectures are more or less complex and more or less bulky. It is also apparent that certain architectures require a considerable technical know-how to be used under correct safety conditions, in particular as far as fitting of the rope and clamping of the rope are concerned.

The first category of belay device is illustrated by the document FR 2647099 filed by the applicant which uses two pulleys having a flat spot. The two pulleys are fitted movable with respect to one another and one of the pulleys is fitted movable with respect to a base plate. By moving the handle, the friction force applied on the rope running between the two pulleys can be adjusted. This configuration is particularly efficient, but it proves to be bulky and heavy which makes it rather impractical for a large number of activities and in particular for rock climbing and mountaineering.

A configuration is also known using several pulleys fitted on a mounting plate, one of the pulleys having a rotating shaft movable in translation on the mounting plate. Exemplary embodiments are illustrated in the documents DE391582, FR7623143 or DE2412987. These configurations are unsuitable for present-day uses in work or leisure activities at height where the belay device has to be easily transportable and where the friction force of the device has to be easily adjustable. These configurations are also cumbersome. In these architectures, a pulley is fitted movable in self-rotation and, depending on the load applied, is moved to a clamping position where the rope is clamped. In alternative embodiments, a handle is used to move the pulley and adjust the friction force. In other variants, a spring is compressed and opposes clamping of the rope below a threshold stress.

Lighter configurations more suitable for portable use exist and are represented by the documents DE200217102996, IT1196979, WO2011/007225. These documents illustrate a belay device having a body defining an aperture passing through the body to enable a carabiner to be inserted. A rope loop is inserted in the body and is taken up by the carabiner so that, when the rope is tensioned, the latter is wedged between the carabiner and the body. Substantially equivalent rope clamping systems are illustrated in the documents U.S. Pat. No. 1,021,986 and US2008/0245611.

Finally, a last category of belay devices exists having a body allowing a rope loop to be inserted. The body operates in conjunction with a cam fitted movable in rotation. The rope loop passes behind the cam so that, when the rope is tensioned, the rope is wedged between the cam and the body. A handle is used to move the cam with respect to the body thereby adjusting the friction force. A first teaching is proposed through the document WO2010/049597 with a handle fitted in eccentric manner on a roller that clamps the rope between two pulleys.

Rotation of the handle enables the space between the roller and pulleys to be adjusted so as to modulate the friction force. In practice, use of this architecture is not satisfactory.

An alternative configuration is disclosed in the document EP3263182 in which the body has a through hole in which the carabiner attached to the user's harness is fitted. The cam also has a larger through hole than that of the body so as to allow the carabiner to be fitted without preventing movement of the cam independently from the body and from the carabiner depending on actuation of the handle fitted on the body. In use, this configuration does not prove totally satisfactory.

### OBJECT OF THE INVENTION

One object of the invention consists in providing a belay device that is easily transportable and that provides an improved operation compared with configurations of the prior art.

This requirement tends to be met by means of a belay device for a rope having a first diameter comprising:
a body defining an inlet for inserting a rope loop,
a shaft and a clamping part fitted on the body, the shaft extending in a longitudinal direction,
an attachment opening designed to collaborate with a connecting part mechanically connecting the belay device with an attachment point, the connecting part being inserted in the attachment opening,
a cam fitted at least rotating on the shaft, the cam having a first end moving in rotation along a path so as to move towards or away from the clamping part and to define a first position where the distance between the cam and the clamping part is minimal and a different second position.

The belay device is remarkable in that the cam, the body and the clamping part are arranged to define a running path of the rope where a rope strand is designed to pass between the cam and the clamping part. The belay device is also remarkable in that the first end defines a through opening forming the attachment opening so that the attachment opening is fitted movable at least in rotation with respect to the body along the path so as to vary the distance between the attachment opening and the clamping part.

In one development, the extension in the longitudinal direction of the inner surface of the first end defining the through opening is devoid of any facing with the body.

In a particular embodiment, the body defines an aperture along the path, the aperture having a larger width than the width of the through opening over the path, the width being measured in the longitudinal direction connecting the rotating shaft and the first end.

In advantageous manner, a spring is fitted on the cam so as to move the cam away from the first position.

Preferentially, the cam has a second end demarcating a second through opening defining a functional clearance with the shaft to allow another movement of the first end in addition to rotation.

It is advantageous to provide for the spring to be fitted in the second through opening.

In an advantageous embodiment, the body defines a ramp and the cam has a salient area sliding along the ramp when movement of the first end takes place according to the path.

In another development, the ramp defines a stop blocking the first end in the clamping position and/or a stop blocking the first end in the other position.

Advantageously, the cam and/or body are not provided with a handle configured to simultaneously press on the body and on the cam.

It is a further object of the invention to provide a belay system that is easily transportable and that presents an improved operation compared with configurations of the prior art.

This requirement tends to be met by means of a belay system comprising a belay device for a rope having a first diameter and a connecting part fitted so as to mechanically connect the belay device to an attachment point, wherein the belay device is provided with:
a body defining an inlet for inserting a rope loop,
a shaft and a clamping part fitted on the body, the shaft extending along a longitudinal direction,
an attachment opening collaborating with the connecting part mechanically connecting the belay device with the attachment point, the connecting part being inserted in the attachment opening,
a cam fitted at least rotating on the shaft, the cam having a first end moving at least in rotation along a path so as to move towards or away from the clamping part and to define a first position where the distance between the cam and the clamping part is minimal and a different second position.

The belay system is remarkable in that the cam, the body and the clamping part are arranged to define a running path of the rope where a strand of rope is designed to pass between the cam and the clamping part.

The belay system is also remarkable in that the first end defines a through opening forming the attachment opening so that the attachment opening is fitted movable at least in rotation with respect to the body along the path, and in that the connecting part is devoid of any physical contact with the body in the clamping position.

In one development, the cross-section of the through opening in a plane perpendicular to the longitudinal axis of the rotating shaft and the cross-section of the connecting part are non-circular to form an anti-rotation means of the connecting part with respect to the through opening.

In a particular embodiment, the connecting part has a cross-section representing at least 75% of the cross-section of the through opening, the cross-section being measured in a plane perpendicular to the longitudinal axis of the shaft.

Preferentially, the rotating shaft demarcates the insertion inlet so that the rotating shaft is designed to press on the tensioned rope strand.

It is a further object of the invention to provide a method for use of a belay system that is easy to implement.

The method is remarkable in that it comprises:
providing a belay system according to any one of the foregoing embodiments, a rope loop passing through the insertion inlet with a first strand connected to the load to be belayed and a second strand, the second strand coming into contact with the clamping part,
tensioning the rope, the rope being clamped between the first end and the clamping part,
applying a stress on the body so as to make the body rotate in a direction of rotation going from the rotating shaft to the clamping part via the first end of the cam.

### BRIEF DESCRIPTION OF THE DRAWINGS

Other advantages and features will become more clearly apparent from the following description of particular embodiments and implementations of the invention given for non-restrictive example purposes only and represented in the appended drawings, in which:

FIG. 1 represents a schematic view of a belay device according to one embodiment of the invention for use with one rope or with two ropes;

FIG. 2 represents a schematic view of a belay device according to another embodiment of the invention for use with one rope or with two ropes;

FIG. 3 represents a schematic view of a belay device as illustrated in FIG. 1 without a rope, with the cam salient from the body;

FIG. 4 represents a schematic view of a belay device as illustrated in FIG. 1 without a rope, with the cam salient from the body;

FIG. 5 schematically represents a longitudinal cross-section of a belay device with a rope fitted, the cam being in a standby position not performing clamping of the rope;

FIG. 6 schematically represents a longitudinal cross-section of an identical belay device to that of FIG. 5 with a rope fitted, the cam being in a clamping position performing clamping of the rope;

FIG. 7 schematically represents a longitudinal cross-section of an identical belay device to that of FIG. 5 with a rope fitted, the cam being in a position allowing sliding of the rope, the device being provided with a handle;

FIG. 8 schematically represents an exploded view of the belay device according to FIGS. 5 to 7 with the handle;

FIG. 9 schematically represents another embodiment of a belay device in accordance with the device illustrated in FIG. 3 with a fixed handle;

FIG. 10 schematically represents another embodiment of a belay device in accordance with the device illustrated in FIG. 3 with a fixed handle;

FIG. 11 schematically represents a longitudinal cross-section of a belay device according to FIGS. 9 and 10 with a rope fitted, the cam being in a standby position not performing clamping of the rope;

FIG. 12 schematically represents a longitudinal cross-section of a belay device according to FIGS. 9 and 10 with a rope fitted, the cam being in a clamping position performing clamping of the rope;

FIG. 13 schematically represents a longitudinal cross-section of a belay device according to FIGS. 9 and 10 with a rope fitted, the cam being in a position allowing sliding of the rope by means of rotation of the belay device;

FIG. 14 schematically represents an exploded view of the belay device according to FIGS. 9 to 13;

FIG. 15 schematically represents a further embodiment of a belay device;

FIG. 16 schematically represents another further embodiment of a belay device;

FIG. 17 schematically represents a longitudinal cross-section of a belay device according to FIGS. 15 and 16 with a rope fitted, the cam being in an insertion position of the rope;

FIG. 18 schematically represents a longitudinal cross-section of a belay device according to FIGS. 15 and 16 with a rope fitted, the cam being in an intermediate position not performing clamping of the rope, the through opening being facing the aperture arranged in the body to insert a connecting part in the aperture;

FIG. 19 schematically represents a longitudinal cross-section of a belay device according to FIGS. 15 and 16 with a rope fitted, the cam being in a clamping position performing clamping of the rope, the through opening being facing the aperture arranged in the body;

FIG. 20 schematically represents a longitudinal cross-section of a belay device according to FIGS. 15 and 16 with a rope fitted, the cam being in a position allowing sliding of the rope by rotation of the belay device, the through opening being facing the aperture arranged in the body;

FIG. 21 schematically represents an exploded view of the belay device according to FIGS. 15 to 20;

FIGS. 22 and 23 represent an embodiment in which the belay device is intended for a double rope.

### DESCRIPTION OF THE EMBODIMENTS

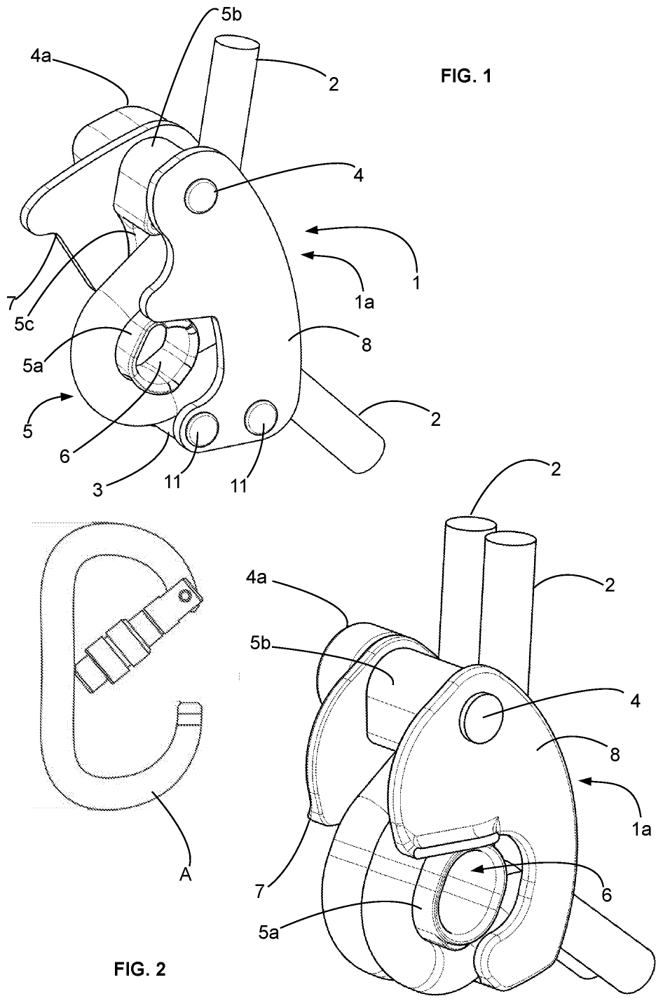

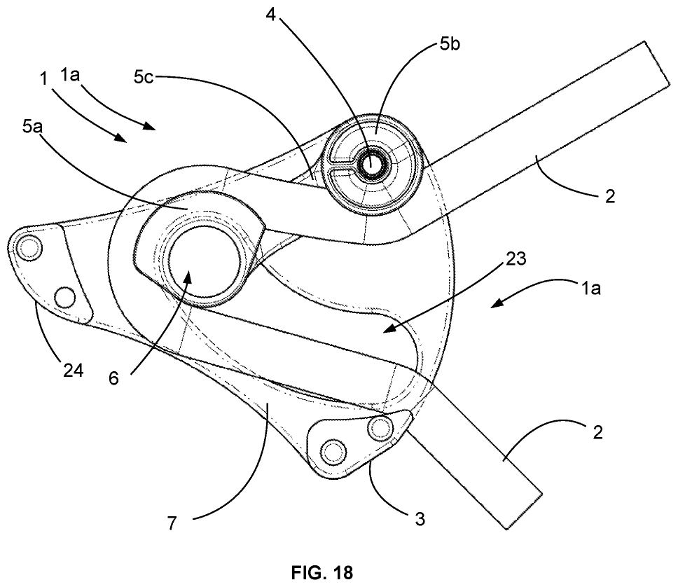

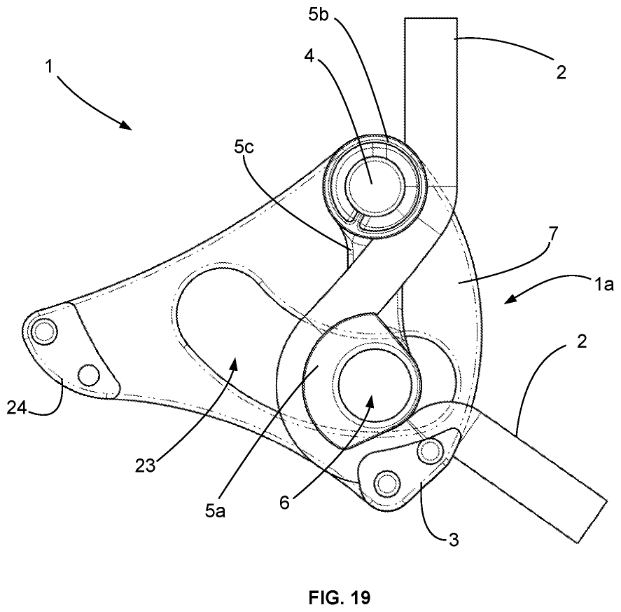

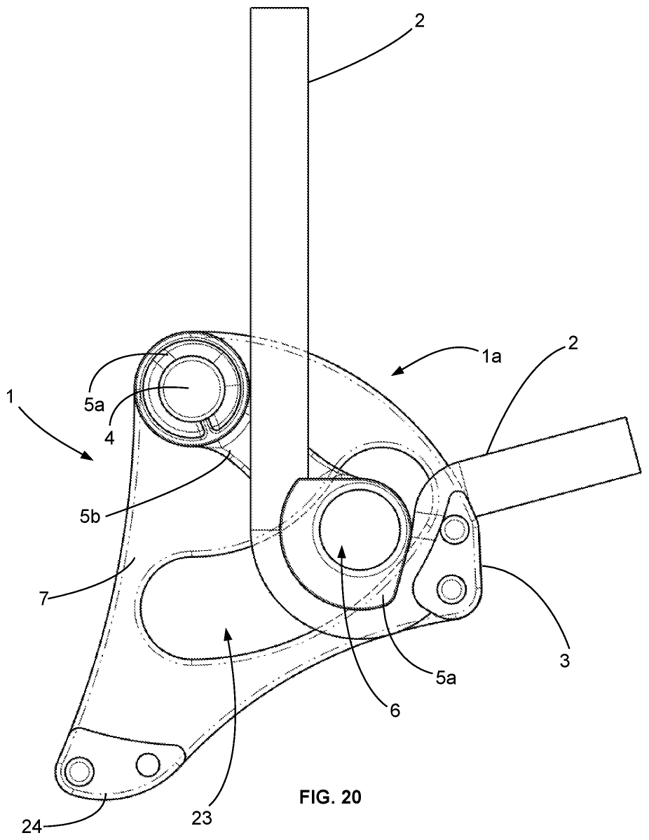

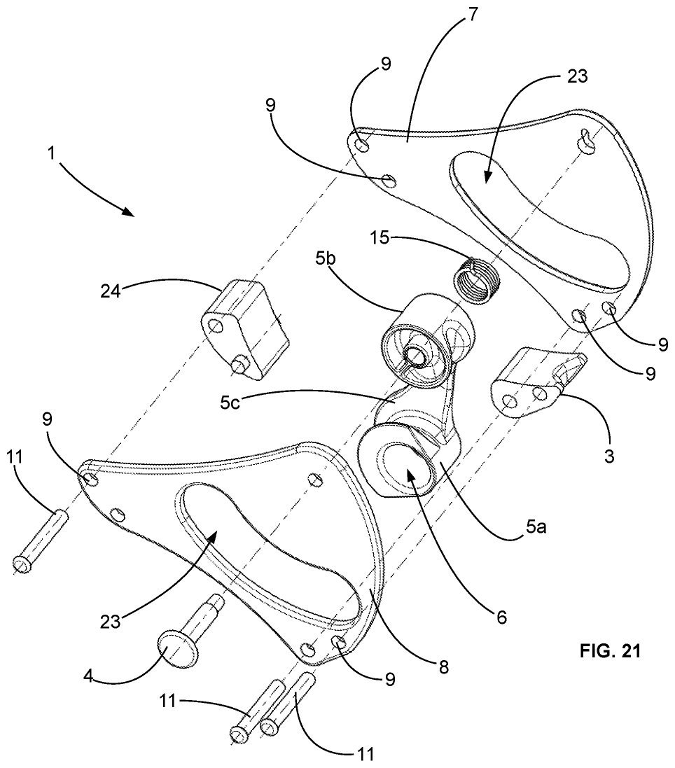

The belay device as illustrated in FIGS. 1 to 23 is a belay device designed to collaborate with at least one rope having a first diameter and to define at least a clamping position of the rope and a running position of the rope or ropes in the belay device.

The belay device comprises a body 1 with an opening defining an inlet 1a for insertion of a rope loop 2 or two loops of two ropes 2. A clamping part 3 is fitted in the belay device and will operate so as to block rope 2 or ropes 2. An inlet is demarcated by two edges.

In advantageous manner, clamping part 3 is preferentially mounted stationary inside the belay device. For example, clamping part 3 is fitted on body 1.

The belay device comprises a shaft 4 that is a rotating shaft. Shaft 4 is fitted on body 1. Depending on the embodiments, shaft 4 is mounted stationary on body 1 or it is mounted movable in self-rotation. In a configuration not shown, the shaft 4 is fixedly mounted on the cam 5 and movable relative to the body. In another configuration not shown, the shaft 4 is mounted movably relative to the body and relative to the cam 5. Shaft 4 is distinct from clamping part 3. It is preferable to have a stationary clamping part 3 to improve clamping of rope 2. Clamping part 3 defines one end of inlet 1a. In a particular embodiment, the two opposite ends of inlet 1a are defined by clamping part 3 and shaft 4.

The belay device comprises a cam 5 mounted on shaft 4 so as to be movable at least in rotation with respect to body 1. Cam 5 moves in rotation along a path defined by shaft 4. Cam 5 moves in a plane that passes through clamping part 3 and shaft 4 so that cam 5 can move towards or away from clamping part 3. In other words, the rotation plane of cam 5 is perpendicular to the direction of rotation defined by shaft 4 and the rotation plane passes through cam 5 and clamping part 3.

Cam 5 moves between a clamping position where the distance between cam 5 and clamping part 3 is smaller than the first diameter of the rope and another position where the distance between cam 5 and clamping part 3 is larger than the diameter of the rope. Cam 5 is movable at least in a half-space separated from the half-space containing insertion inlet 1a of rope loop 2. The two half-spaces are separated by a plane containing the axis of rotation of cam 5 and passing through clamping part 3. Movement of cam 5 makes it possible to define a position where the rope is clamped and a position where the rope can run inside the belay device.

Depending on the embodiments, cam 5 passes or does not pass through insertion inlet 1a.

Cam 5 has an apertured first end 5a defining a through opening 6 in a direction parallel to the longitudinal axis of shaft 4. Through opening 6 is designed to receive a connecting part A that performs the mechanical connection between the belay device and an attachment point.

The attachment point can be a harness worn by the user or an anchoring point, for example an anchoring point placed on a rock, on ice, or an artificial climbing structure or another type of artificial structure.

The connecting part A can be a carabiner, a quick link, a shackle or any other mechanical item able to perform mechanical connection between the attachment point and the belay device.

The first end 5a forms a ring which defines the through opening. The ring is configured to provide sufficient mechanical strength when the rope is under tension to maintain the mechanical connection between the attachment point and the belay device.

Cam 5 has an apertured first end 5a that is mechanically connected to shaft 4 by means of a second end 5b and arm 5c and so that through opening 6 moves around shaft 4. Second end 5b is fitted on shaft 4. The first end 5a is configured to lock the rope 2 between the ring and the blocking element 3. First end 5a defines a ring that separates the connecting part A and rope 2 enabling clamping to be made more reliable by not having to take account of the surface state, cross-section and diameter of the connecting part A in the interaction between the rope and connecting part A. First end 5a is configured to clamp rope 2 between the ring and clamping part 3.

In advantageous manner illustrated in FIGS. 1 to 21, arm 5c defines a groove enabling a strand of rope 2 to be inserted between apertured first end 5a and shaft 4. Other configurations are possible with a cam 5 offset with respect to the end of shaft 4 and an arm 5c that may be solid, but this embodiment may be less compact and/or less practical. The groove defines a larger width than the diameter of rope 2 which enables the rope to be clamped against the clamping part without having clamping of the rope between the ring and the shaft or the second end. The rope loop pass around the ring of the first end 5a.

Body 1 and cam 5 are configured so as to allow movement of cam 5 and of the connecting part A with respect to body 1 along the path between the clamping position and the other position. Body 1 and cam 5 are advantageously configured so that movement of cam 5 along the path results in a movement of the connecting part A along the path and/or movement of the connecting part A along the path results in movement of cam 5 along the path.

First end 5a moves between a first position representative of the clamping position where the distance between first end 5a and clamping part 3 is minimal and another position where the distance is larger. In the clamping position, cam 5 separates clamping part 3 and the connecting part A so as to avoid a direct contact between rope 2 and the connecting part A leading to uncertain clamping of the rope on account of unsuitable connecting part A shapes and above all due to excessive wear of the rope when the connecting part A is damaged. The safety and quality of the clamping are improved. As illustrated in the different figures, in the first position and in the clamping position, the distance between the ring and clamping part 3 is smaller than the distance between the ring and shaft or possibly between the ring and second end.

The first end moves along a path representing an angle preferentially greater than 45° and even more preferentially greater than 60° to facilitate insertion of rope loop 2 in body 1 and fitting thereof around first end 5a without being impeded by cam 5.

The belay device is also configured so that, in the clamping position, the mechanical connection between the belay device and attachment point is made on first end 5a which is simultaneously connected to rope 2 and to the connecting part A.

Unlike architectures of the prior art, the belay device is configured so that rope 2 is pressing on first end 5a of cam 5 and the belay device is mechanically connected to the attachment point by means of a connecting part A that is coupled to through opening 6.

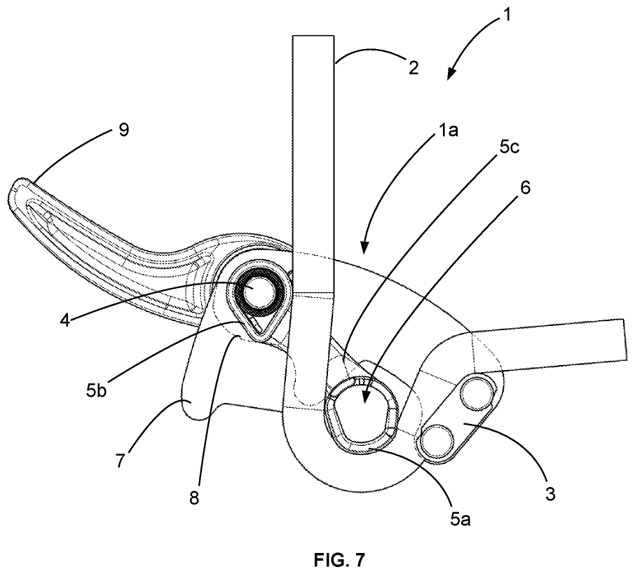

The connecting part A is movable with respect to body 1 and moves along the path even when rope 2 is fitted in body 1. Load take-up between the belay device and the attachment point takes place by means of the connecting part A which is fitted in through opening 6 so that the forces between rope 2 and the connecting part A are applied on first end 5a. In FIGS. 6 and 7, rope 2 pulls the belay device upwards via strand of rope 2 exiting close to shaft 4 and directed vertically whereas the connecting part A fitted in through opening 6 applies an opposite force (directed downwards). As rope 2 defines a loop, tensioning of rope 2 tends to reduce the loop thereby imposing a force on the different contact points between rope 2 and body 1, i.e. the opposite two ends of inlet 1a, here between second end 5b and clamping part 3. Tensioning of rope 2 results in rotation of body 1 to attempt to equalize the forces applied on clamping part 3 and second end 5b. As an alternative, it is possible to provide for rope 2 not to come into contact with second end 5b but with another part located on body 1.

In the proposed configurations, the connecting part A is not fixed directly on the body and preferentially body 1 is not provided with means for fitting a connecting part A. What is meant by not provided with means for fitting a connecting part A is that fitting of the connecting part A will prevent movement of first end 5a over all or part of the path and/or will not define a clamping position of rope 2 and a sliding position.

In the document EP 3263182, a first hole is provided passing through the body for fitting of a carabiner and a larger second hole is provided passing through the movable cam. This configuration is engineered in such a way that the load take-up takes place directly on the body of the belay device and allows movement of the cam independently from the connecting part. When the rope is tensioned, the carabiner comes into direct contact with the body in the clamping position clamping of the rope and even later when the rope moves. A shear force therefore arises applied on the carabiner between the two flange-plates of the body on the one hand and the movable cam on the other hand. The behaviour of the belay device is modified according to the diameter of the rope and also to the diameter and shape of the carabiner used as the latter comes into contact with the wall of the body and with the wall of the cam. It became apparent that this configuration was not practical to use as it requires the use of a handle that has to be sufficiently integrated in the device so as not to hamper use of the belay device while at the same time being sufficiently practical to use. It is also apparent that compulsory use of a handle may impede clamping of the rope.

In the document WO2010/049597, the belay device is connected to the attachment point by means of a carabiner fixed to the body. There again, tensioning of the rope causes the latter to be clamped between the roller and body which requires use of the handle to move the roller and make the rope slide. As for the previous device, it is impossible to release the rope without using the handle which makes it complicated to use and may result in difficulty in clamping the rope if the handle is not correctly fitted. This device is more voluminous than the one presented in FIGS. 1 to 23.

The configuration illustrated in FIGS. 1 to 23 is particularly advantageous as the load take-up obtained by fitting the connecting part A in through opening 6 of cam 5 without a direct load take-up between the connecting part A and body 1 enables body 1 and cam 5 to move more easily under load. It is apparent that with this configuration, movement of through opening 6 and therefore of the connecting part A with respect to body 1 along the path enables the position of first end 5a of cam 5 to be offset with respect to clamping part 3 when rope 2 is tensioned.

In other words, a first force is applied by rope 2 pressing against clamping part 3 and a second force is applied by the connecting part A on second end 5b of cam 5. Rotation of body 1 by the user makes it possible to move body 1 with respect to first end 5a of cam 5 and therefore to modify the distance between first end 5a and clamping part 3 so as to adjust the friction on rope 2 thereby modulating the running speed of rope 2.

Tensioning of rope 2 will move first end 5a with respect to body 1 in order to move first end 5a towards the contact points between rope 2 and body 1. As cam moves along the path, movement of cam 5 moves first end 5a towards clamping part 3. Rotation of body 1 by means of rotating shaft 4 in contact with the tensioned rope strand enables the force applied on rope 2 in the direction of the clamping part to be modulated thereby modulating the stress on rope 2 which prevents sliding of the rope inside the belay device.

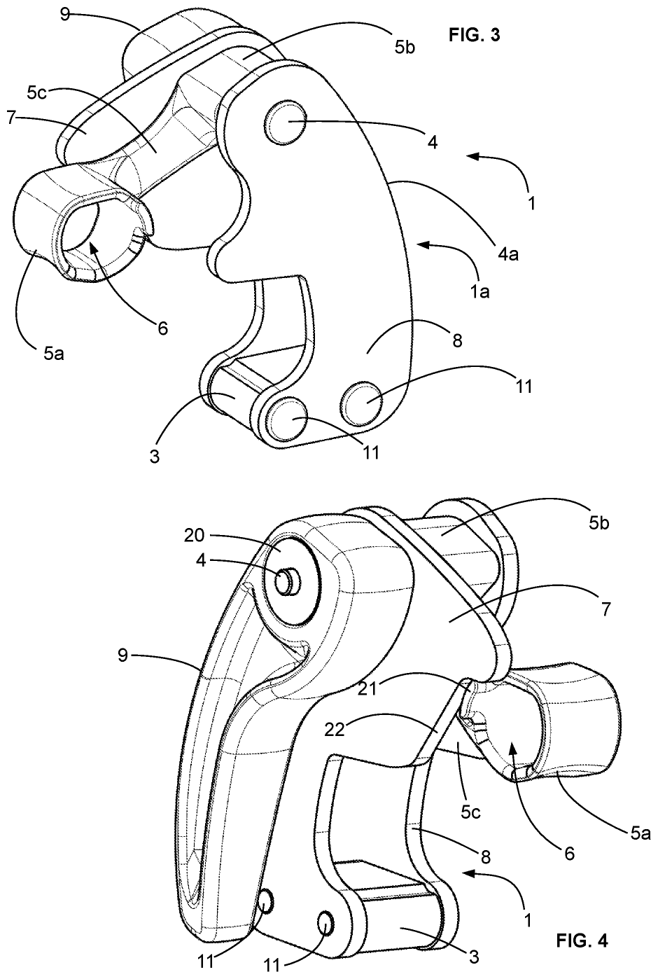

As illustrated in FIGS. 1 and 2, the belay device can be configured to operate with a single strand of rope 2 (FIG. 1) or with two strands of rope (FIG. 2). In an operation with two strands of rope 2 fitted in parallel in the longitudinal direction of rotating shaft 4 of cam 5, it is possible to provide for the belay device to have two cams 5 fitted on a single rotating shaft 4. The belay device can be configured so that the two ropes 2 are in contact with one another or so that the two ropes 2 and two cams 5 are separated by a separating flange-plate (not shown).

In the embodiment illustrated in FIGS. 1, 2, 3 and 4, body 1 comprises two flange-plates 7 and 8 defining a work space inside which rope loop or loops 2, cam 5 and rotating shaft 4 are fitted. In the illustrated embodiment, flange-plates 7 and 8 are flat and parallel, but it is also possible to provide flange-plates 7 and 8 that are not flat and/or not parallel. It is also possible to provide for shaft 4 to be fitted outside the work space. In advantageous manner, inlet 1a designed to receive rope loop 2 is demarcated by the two flange-plates 7 and 8, by clamping part 3 and also by another part extending between the two flange-plates, advantageously shaft 4, but an additional part can be fitted in order to prevent or reduce contact with the shaft. The cavity suitable for the passage of the rope loop may be delimited by the second end 5b as shown in FIGS. 5 to 7, 11 to 13, 17 to 20 and 23.

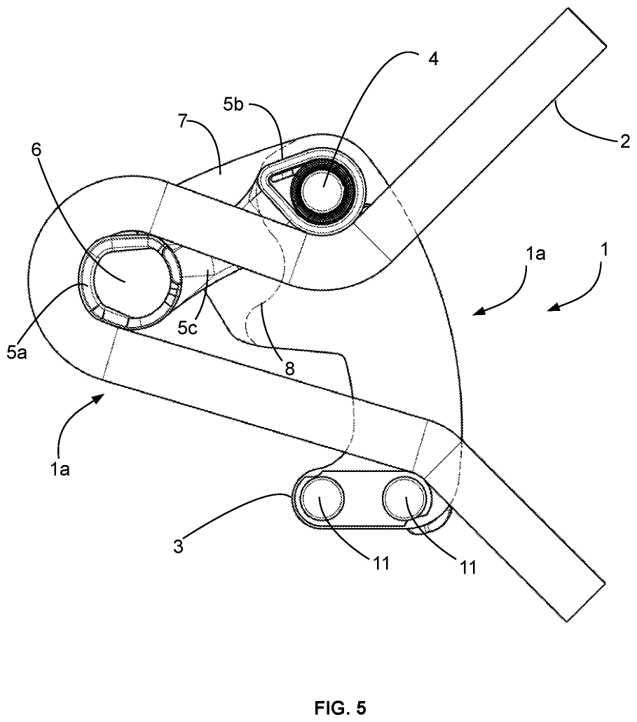

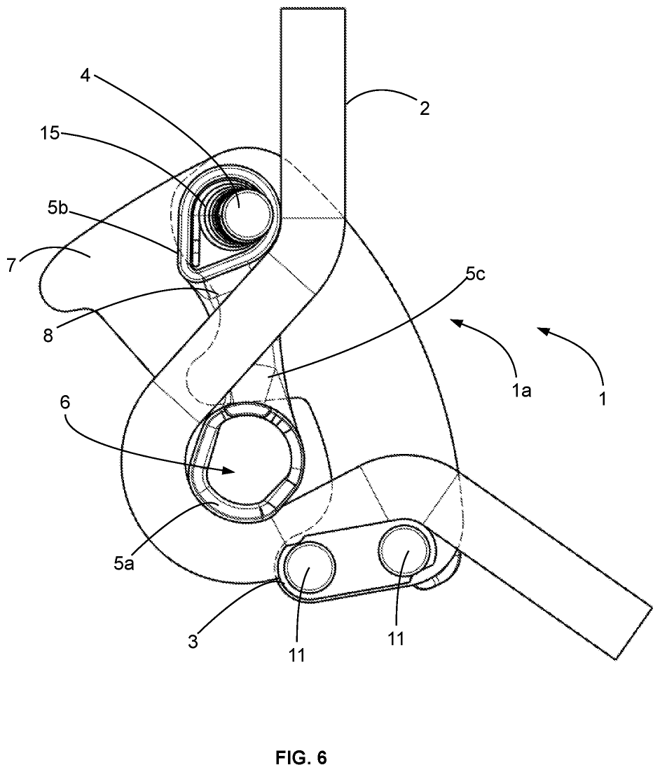

In the embodiment illustrated in FIGS. 3 and 4, a handle 9 is fitted on one of the flange-plates, here flange-plate 7. Handle 9 is fitted movable with respect to body 1, advantageously movable in rotation at least in a first direction of movement from a first position to a second position. Handle 9 defines a first position in which handle 9 can move independently with respect to body 1, i.e. movement of handle 9 does not have any effect on movement of body 1. Handle 9 defines a second position in which handle 9 can no longer move with respect to body 1. In the illustrated example, handle 9 moves from the first position to the second position, movement taking place in rotation with respect to body 1. Once the second position has been reached, a force in the first direction of movement makes the body move with handle 9. Handle 9 is then immovable with respect to body 1. From the second position, handle 9 can move with respect to body 1 to the first position. Handle 9 is not mechanically connected to cam 5, i.e. handle 9 is not in mechanical contact on the one hand with body 1 and on the other hand with cam 5 to allow movement of cam 5 with respect to body 1 as in the prior art.

It is advantageous to provide for the rotating shaft of handle 9 to be shaft 4 which is mechanically more efficient to cause rotation of body 1 with respect to cam 5. In this exemplary case, rotation of handle 9 from the first position to the second position does not have any effect on the position of cam 5 with respect to body 1. Handle 9 does not act as a lever between cam 5 and body 1.

FIGS. 5, 6 and 7 illustrate, in cross-section, the path taken by a strand of rope 2 inside the belay device. FIG. 5 illustrates installation of rope loop 2 inside the belay device via inlet 1a so that rope loop 2 passes behind first end 5a of the cam. The end of rope 2 fixed to the load to be belayed exits the belay device in contact with rotating shaft 4 or close to rotating shaft 4, for example in contact with second end 5b of cam 5 opposite first end 5a of cam 5. Flange-plate 8 is absent and is illustrated in a broken line for greater clarity.

FIG. 6 illustrates a configuration where rope 2 is tensioned, and the end of the strand connected to the load to be belayed (the vertical strand directed upwards) is pressing on body 1 for example on shaft 4 and/or on second end 5b. A force is applied upwards and another force is applied downwards from through opening 6. When tensioning takes place, the strand presses on first end 5a, in contact with cam 5, and wedges rope 2 between first end 5a and clamping part 3. Tensioning of rope 2 causes rotation of cam 5 so as to reach the clamping position of rope 2 or from another point of view causes rotation of body 1 until clamping of the rope takes place.

FIG. 7 illustrates rotation of body 1 with respect to what is illustrated in FIG. 6. Rotation of body 1 takes place with respect to second end 5b so that the downward vertical force applied on through opening 6 moves away from clamping part 3 and the stress applied to clamp rope 2 therefore decreases. Once a rotation threshold value has been reached, the force applied by the securing part on first end 5a is expressed by an increase of the distance between first end 5a and clamping part 3 which enables rope 2 to slide.

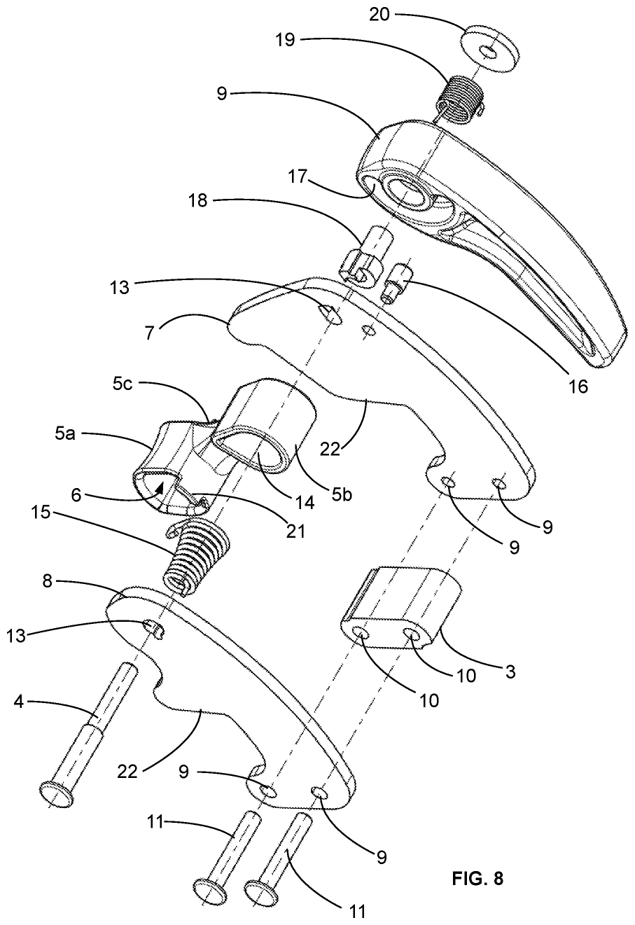

FIG. 8 illustrates an exploded view of an embodiment of a belay device. The device comprises two flange-plates 7 and 8 connected to one another by means of clamping part 3. The two flange-plates 7 and 8 each comprise two holes 9 collaborating with two holes 10 of clamping part 3. Two connectors 11 pass through holes 9 and 10 of flange-plates 7 and 8 and of clamping part 3 thereby enabling the two flange-plates 7 and 8 separated by clamping part 3 to be secured to one another.

The two flange-plates 7 and 8 comprise an additional hole 13 and rotating shaft 4 passes through additional holes 13. Cam 5 comprises opposite first and second ends 5a and 5b separated by an arm 5c. The two ends each define a through opening. Shaft 4 passes through opening 14 of second end 5b. In the illustrated embodiment, a spring 15 is fitted around shaft 4. Spring 15 is advantageously fitted in through opening 14 of second end 5b. This configuration makes it possible to simply form two flange-plates 7 and 8 mounted secured to one another and defining a work space inside which rotating shaft 4, spring 15, cam 5 and clamping part 3 are located.

The embodiment illustrated in FIG. 8 has a handle 9 mounted movable in rotation, advantageously around shaft 4. The flange-plate has a salient part 16 16 which circulates inside a cavity 17 arranged in handle 9 so as to allow movement of handle 9 to the threshold position where the force applied on handle 9 causes rotation of body 1.

Handle 9 is fitted on a shaft 18 advantageously extending shaft 4. Handle 9 operates in conjunction with an additional spring 19 configured to bias handle 9 to the first position. Handle 9 defines a cavity to house spring 19 and the cavity can be closed off by a cover 20.

Cam 5 has a salient area 21 which slides on a ramp 22 of flange-plate 7 or 8 or on both of the flange-plates.

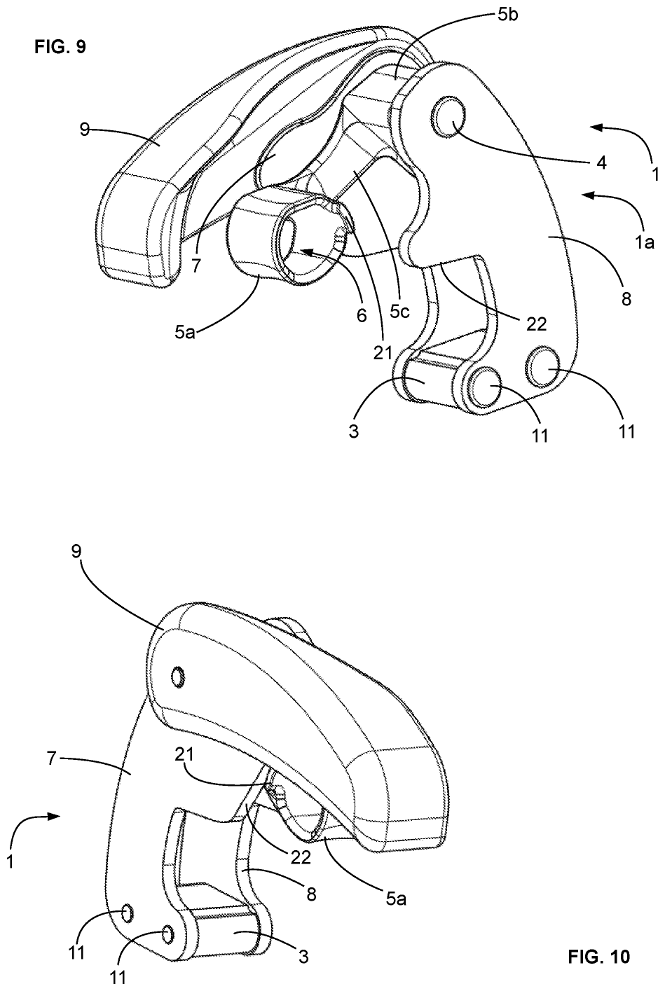

FIGS. 9 and 10 illustrate another embodiment of a belay device in which handle 9 is advantageously mounted stationary with respect to body 1 so that rotation of handle 9 in one direction of rotation or in the opposite direction automatically results in rotation of body 1 in the direction of rotation or in the opposite direction.

In the same way as for the previous embodiment, it is advantageous to have a body 1 provided with two flange-plates 7 and 8 fitted at a distance from one another. Cam 5 is mounted rotating on shaft 4. First end 5a of cam 5 defines a through opening 6 for installation of a connecting part A.

The technical characteristics relating to clamping part 3, rotating shaft 4 and cam presented for the previous embodiment can be used in the embodiment illustrated in FIGS. 9 to 14.

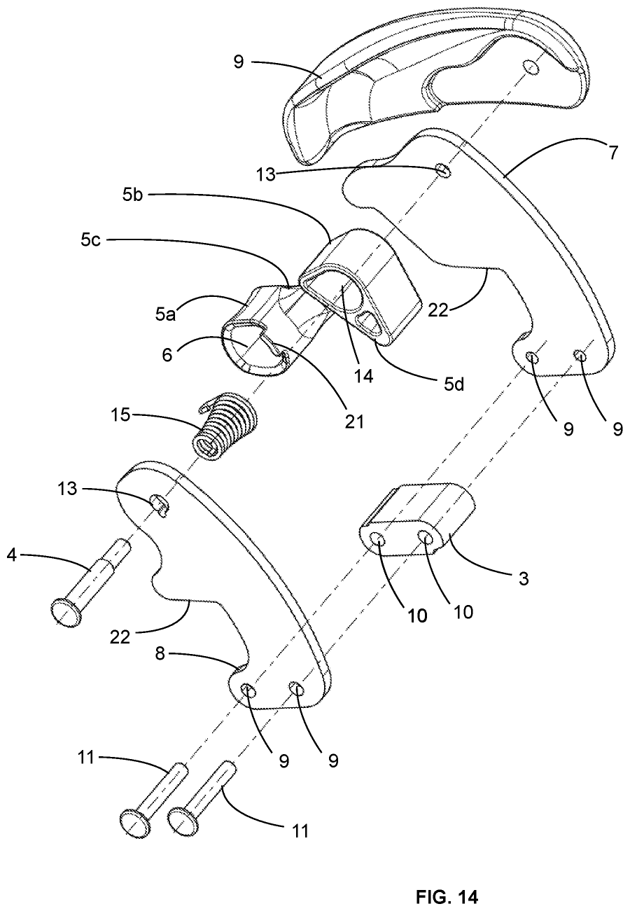

This embodiment can be used with a single rope 2 or with two ropes 2. As illustrated in FIG. 14, a spring 15 can be used, but a configuration without a spring is also conceivable. The illustrated belay device presents a second end 5b defining a through opening 14 having a larger cross-section than the external cross-section of shaft 4 which makes it possible to have a rotational movement coupled to another movement of cam 5. As an alternative, cam 5 can present a single rotational movement. In the same way as for the previous embodiment, through opening 6 does not define a circular cross-section which enables a better load take-up between cam 5 and the connecting part A and therefore a better modulation of sliding of rope 2 to be obtained by also using a connecting part A not having a circular cross-section. The use of non-circular sections makes it possible to form an antirotation means between the connection element A and the through opening 6. In general, the cam 5 can be mounted to be mobile only in rotation but it is advantageous to the cam to be mounted mobile in rotation and in another movement by means of a functional clearance that exists between the cam 5 and the shaft 4 and/or between the shaft 4 and the body 1, for example the two flanges 7/8. The functional clearance allows better management of the movement of the body relative to the ring when the rope is under stress and is locked between the ring and the blocking element 3. The second end can move for example in rotation when the first end 5a is blocked for example in abutment against the body.

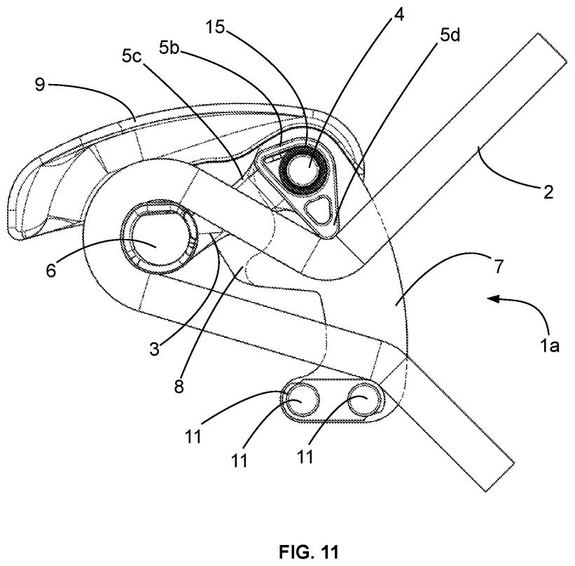

FIGS. 11, 12 and 13 illustrate three steps of operation of the belay device. FIG. 11 illustrates fitting of rope 2 in the belay device via insertion inlet 1a. Rope 2 passes between first end 5a and second end 5b so that rope 2 presses on first end 5a of cam 5 when rope 2 is tensioned which will clamp rope 2 between cam 5 and clamping part 3.

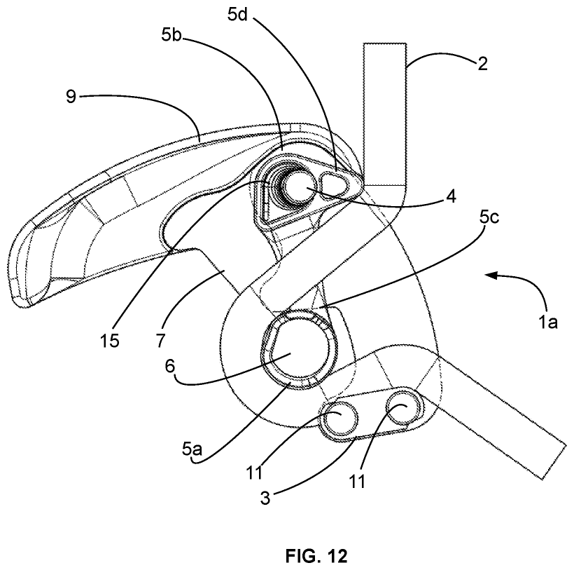

FIG. 12 illustrates a position where cam 5 clamps rope 2. An upward vertical force is applied by strand of rope 2 which presses on rotating shaft 4 whereas a downward vertical force is applied by the connecting part A on through opening 6 which makes the belay device and in particular body 1 rotate in counter-clockwise manner according to the illustrated configuration.

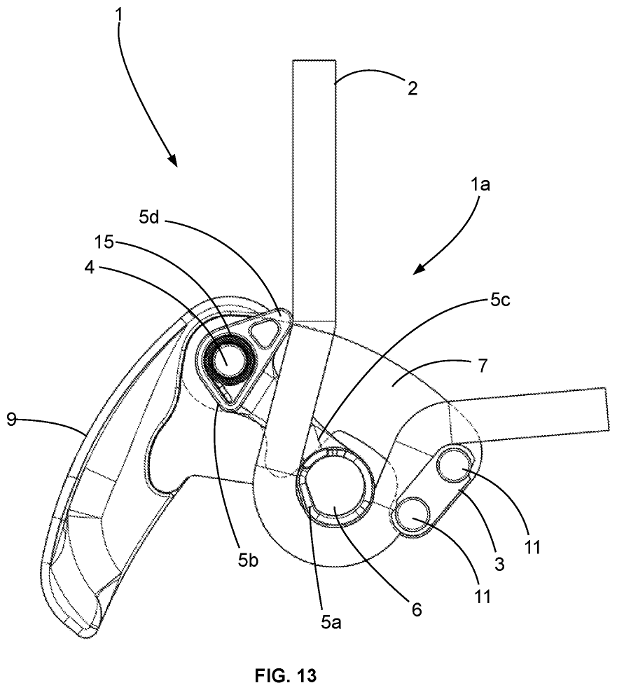

FIG. 13 illustrates a counter-clockwise rotation of body 1 with respect to what is illustrated in FIG. 12 which has the effect of reducing the stress applied on rope 2 by first end 5a of cam 5.

FIGS. 5, 6, 7 on the one hand and FIGS. 11, 12, 13 on the other hand illustrate movement of rotating shaft 4 inside through opening 14 of second end 5b of cam 5. These figures show that when rotation of cam 5 takes place, the bearing point between shaft 4 and spring 15 is displaced with a trajectory which is not purely circular. In one embodiment, it is possible to define the modification of the path of cam 5 with respect to a purely circular trajectory by defining the shape of through opening 14 of second end 5b. As an alternative or as a complement, the trajectory can be defined by means of a salient area 21 that slides along a ramp 22 present on body 1, here on flange-plate 8. This configuration is also present in the embodiments illustrated in FIGS. 1 to 8. It is also advantageous to provide that the second end does not have a circular outer surface so that the stress applied to the second end 5b when the cord is under tension moves the ring toward the blocking member as shown in FIGS. 1 to 14 and 22 to 23

In the embodiment illustrated in FIGS. 9 to 14, first end 5a comprises salient area 21 which extends perpendicularly to the direction connecting shaft 4 and first end 5a and in the direction of clamping part 3 to slide on the bearing surface of flange-plate 8 which defines inlet 1a.

FIG. 14 illustrates an exploded view of the embodiment described in the foregoing. The configuration is identical to that of FIG. 8 except for handle 9 which is mounted stationary on flange-plate 8.

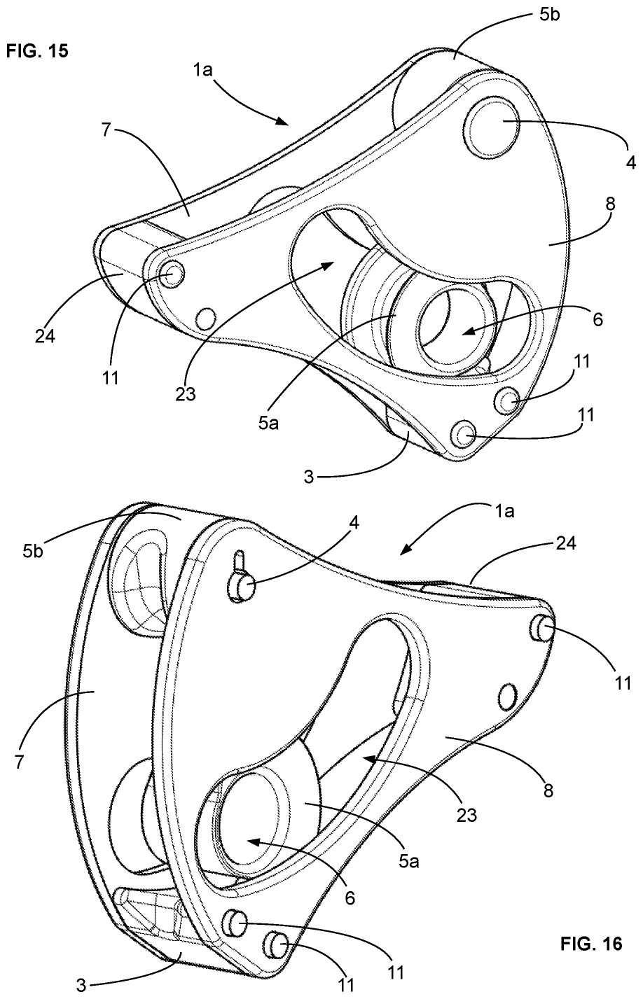

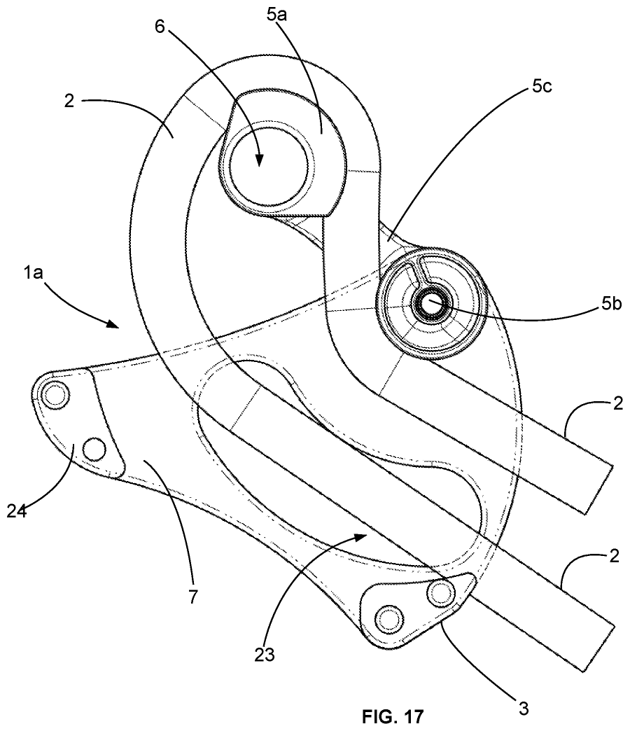

FIGS. 15 to 21 illustrate another embodiment. In this configuration, cam 5 is mounted only in rotation around shaft 4. As illustrated in FIGS. 15 and 16, body 1 is provided with two flange-plates 7 and 8 each defining an aperture 23 that follows the path of first end 5a. The width of aperture 23 is larger than the width of through opening 6, the width being measured in a direction contained in the plane of movement of cam 5, preferably along the longitudinal axis of cam 5 which extends perpendicularly to the longitudinal axis of shaft 4. The larger width of aperture 23 prevents the connecting part A from pressing directly on body 1. This configuration facilitates rotation of body 1 under load by preventing a tensile stress from being applied on the body as is the case in the prior art.

In the illustrated configuration, body 1 has two flange-plates 7 and 8 each defining an aperture 23 for the connecting part A to pass through. As an alternative, only one of flange-plates 7 or 8 defines aperture 23 whereas the other flange-plate 8 or 7 does not face first end 5a. In another configuration, neither of flange-plates 7 and 8 is facing through opening 6 of first end 5a in a direction parallel to the longitudinal axis of the shaft as illustrated in FIGS. 1 to 14. The two flange-plates are separated by cam 5, clamping part 3 and spacer 25.

This embodiment can be combined with the use of a spring 15 which moves cam away from clamping part 3 as in the previous embodiments. In the illustrated embodiment, apertures 23 define an arc of a circle the centre of which is defined by rotating shaft 4. Other shapes of apertures 23 are possible provided that they do not result in a load take-up of the connecting part A by body 1. If the belay device is configured so that first end 5a of cam 5 performs a more complex movement than a simple rotation, the shape of apertures 23 can be adapted to match the shape of the path of first end 5a.

In a particular configuration that is not illustrated, aperture 23 demarcates a ramp 22 collaborating with a salient area 21 of cam 5 to define the path of cam 5. In this particular case, aperture 23 extends up to an edge of a flange-plate to allow fitting and removal of first end 5a of rope. It is further possible to combine different illustrated embodiments to obtain a cam 5 mounted movable only in rotation in a belay device that is devoid of an aperture 23 and possibly of a ramp 22 and a salient area 21 sliding on ramp 22. Preferentially, the belay device has an additional securing part 24 for securing the two flange-plates to one another

In advantageous manner, first end 5a defines a closed ring around through opening 6 to enhance the mechanical strength. Cam 5 is advantageously made from metal, preferably from steel or aluminium alloy. The two flange-plates 7 and 8 are advantageously made from metal, preferably from steel or from aluminium alloy. In advantageous manner, the ring is configured to allow movement of the rope in both directions. The outer wall of the ring is preferentially devoid of spikes to prevent the rope from only running in one direction in contact with the first end of the cam. In a preferential configuration, the outer wall of the ring is smooth and can define a smooth groove. It is also possible to provide for the outer wall to be textured to increase the quality of contact between the rope and the ring thereby facilitating automatic clamping of the belay device when the rope strand tends to move the ring towards clamping part 3.

The belay device is associated with a connecting part A to form a belay system. The belay system is fixed to an attachment point which can be worn by the user, for example a harness, or which can be an anchoring point as defined previously. The connecting part A is fixed on the one hand to the anchoring point and on the other hand in through opening 6. When rope 2 is tensioned, first end 5a is pulled to one side (for example upwards) by rope loop 2 whereas the connecting part A opposes such a movement. Body 1 is not subjected to this set of stresses. As rope 2 is tensioned, it seeks to approach a rectilinear configuration so that it comes into contact with two distinct points of insertion inlet 1a and in particular clamping part 3. This coming into contact under stress makes body 1 rotate in a position where the force applied on first end 5a also applies a stress on rope 2 in the direction of clamping part 3 which has the effect of clamping rope 2 in almost automatic manner thereby enhancing safety.

In the illustrated configurations, there is only one clamping point of rope 2 between first end 5a and clamping part 3, whereas in the configurations of the prior art, two circular clamping points are used and the cam places itself substantially on the bisecting line connecting the two centres of the clamping points. The illustrated configurations enable an easier rotation of the device thereby ensuring a better control of the sliding speed.

In devices of the prior art, the rope applies a stress on the cam so as to wedge the cam and therefore the rope against the body. Two substantially identical forces of opposite intensities are respectively applied on the body and on the cam to clamp the rope. Fixing of the belay device is performed by connecting the body directly with the attachment point, i.e. the connecting part A is coupled to an attachment opening arranged in the body. If a rotation of the belay device of the prior art takes place, it does not have any effect.

On the contrary, in the illustrated configurations, an attachment opening is arranged in cam 5. Rope 2 is still fitted on cam 5 so as to be able to slide. The stress applied by tensioned rope 2 pressing on cam 5 against body 1 can be modulated by making body 1 rotate with respect to cam 5 which is made possible by securing belay device via cam 5 and not via body 1.

It is therefore particularly advantageous, along the whole of the trajectory and especially in the clamping position, for the extension of the section of through opening 6 in a direction parallel to the longitudinal axis of shaft 4 not to have any surface facing body 1 thereby preventing the connecting part A from pressing on body 1 which would have the effect of making movement of body 1 with respect to cam 5 more difficult. More precisely, it is particularly advantageous for the half of the section of through opening 6 that is farther away from rotating shaft 4 to be devoid of any surface facing body 1 to reduce the risks of direct contact between the connecting part A and body 1.

In use, the connecting part A is installed in through opening 6 and applies a force tending to move first end 5a away from first opening 1a able to be materialised by a plane connecting the longitudinal axis of shaft 4 and clamping part 3. As the force applied by the connecting part A is directed in such a way as to move away from rotating shaft 4, clamping of connecting part A with body 1 can only take place in the half of rotating shaft 4 that is farther away.

In a particular use, at least one rope loop 2 is inserted in the belay device so that a strand passes between rotating shaft 4 and first end 5a of cam 5 and the strand passes behind first end 5a of cam 5 and exits via insertion inlet 1a. Rope 2 is tensioned making cam 5 rotate so as to clamp rope 2 between clamping part 3 and first end 5a of cam 5. The force applied by the load to be belayed generates a force on rotating shaft 4 whereas the force applied by the connecting part A generates a substantially opposite force making body 1 rotate with respect to cam 5 or making cam 5 rotate with respect to body 1 so that the force applied by the connecting part A generates a force which presses rope 2 against clamping part 3 thereby clamping rope 2.

The user can make body 1 rotate thereby displacing the components of the forces applied by the load to be belayed and by the connecting part A. Rotation of body 1 enables the stress applied on rope 2 to be reduced up to a threshold position where rope 2 can slide in the belay device. The threshold position varies according to the diameter of rope 2 and to the external coating of rope 2 and of clamping part 3.

In the different configurations illustrated, it is particularly advantageous in use for rotating shaft 4 to be arranged in contact with or close to the rope strand which is connected to the load to be belayed and not in contact with or close to the rope strand called “slack”, i.e. the strand of rope designed to be held by the user's hand.

In the document EP 3263182, in use, the carabiner presses on the body and the cam moves in rotation by means of the handle. This results in the carabiner being stationary with respect to the body and in the cam moving with respect to the carabiner and to the body by means of the handle which acts as a lever. The handle is automatically arranged in opposite manner to the “slack” strand which is to be held in the user's hand for safety reasons. An identical conclusion can be drawn from the document WO2010/049597 in which the securing carabiner is fitted around the rotating shaft so as to have the handle on the same side as the tensioned rope strand as the other hand has to hold the “slack” rope strand.

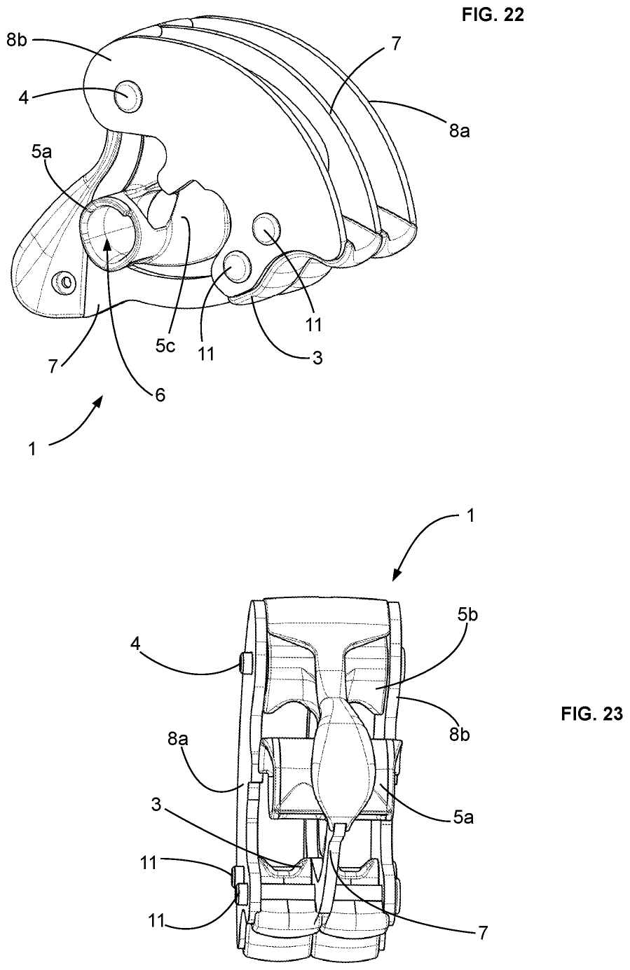

FIGS. 22 and 23 represent an embodiment in which the belay device is configured for two strands of rope. The device has a first flange-plate 7 separating two second flange-plates 8a, 8b. Body 1 defines two inlets 1a for the purposes of inserting two rope loops. The configuration of the belay device is doubled-up with in particular two rings which will operate in conjunction with two clamping parts 3 to clamp the two ropes. In a particular embodiment, the two rings are fitted on the same arm of the cam so that they move in the same manner with respect to the flange-plates. The two rope loops are separated by first flange-plate 7. The two rope loops are formed around the two rings.

1. Belay device for a rope comprising:
a body comprising two flange-plates and first and second edges connecting the two flange-plates, the body defining a through cavity suitable for insertion of a rope loop, the through cavity having an inlet demarcated by the two flange-plates and the first and second edges,
a clamping part fitted on the body and extending along a longitudinal direction, the clamping part connecting the two flange-plates and forming the first edge,
a cam mounted movable with respect to the clamping part, the cam having a first end defining a ring surrounding a through opening along the longitudinal direction, a second end connecting the cam to the body by means of the shaft and an arm connecting the first and second ends, the ring moving at least in rotation around the shaft in a plane perpendicular to the longitudinal direction to move towards or away from the clamping part and to define a first position where a distance between the ring and the clamping part is minimal and to define a second position different from the first position, the ring being closer to the clamping part than to the second edge in the first position,
the through opening forms an attachment opening designed for insertion of a connecting part mechanically connecting the belay device with a user,
wherein the ring extends along the longitudinal direction to be located facing the clamping part in a plane perpendicular to the longitudinal direction to be able to clamp the rope between the ring and the clamping part, the ring providing a separation between the connecting part and the rope, and wherein the ring is located at a distance from the shaft and from the second end to define a cavity allowing a strand of the rope to be inserted between the ring and the second end and/or the shaft between the two flange-plates so as to enable formation of the rope loop around the ring.

2. Belay device according to claim 1 wherein an extension, along the longitudinal direction, of the inner surface of the first end defining the through opening in the ring is devoid of any facing with the body in the first position, in the second position and between the first and second positions.

3. Belay device according to claim 1 wherein the body defines an aperture, the aperture having a larger width than a width of the through opening, the width being measured along a direction connecting the shaft and the first end, the aperture being facing the through opening along the longitudinal direction when the cam is in the first position, in the second position and between the first and second positions to enable movement of the connecting part along the aperture.

4. Belay device according to claim 1 wherein the shaft connects the two flange-plates and the arm is arranged between the two flange-plates and defines the cavity enabling the strand of rope to be inserted between the ring and the second end and/or the shaft by means of a groove between the first end and the second end.

5. Belay device according to claim 1 wherein the second end demarcates a second through opening defining a functional clearance with the shaft to allow another movement of the first end in addition to rotation, the shaft being fitted in the second through opening.

6. Belay device according to claim 5 wherein the second end forms the second edge.

7. Belay device according to claim 5 wherein the first flange-plate or the second flange plate define a ramp and wherein the cam has a salient area sliding along the ramp.

8. Belay device according to claim 7 wherein the ramp defines a block stop blocking the first end in the clamping position.

9. Belay device according to claim 1 wherein the ring has an outer surface defining a smooth groove.

10. Belay device according to claim 1 wherein the outer face of the second end has a part devoid of a circular cross-section in a plane perpendicular to the longitudinal direction and passing through the ring and the clamping part.

11. Belay system comprising a belay device for a rope and a connecting part wherein the belay device is provided with:
a body comprising two flange-plates and first and second edges connecting the two flange-plates, the body defining a though cavity suitable for insertion of a rope loop, the though cavity having an inlet demarcated by the two flange-plates and the first and second edges,
a clamping part fitted on the body and extending along a longitudinal direction, the clamping part connecting the two flange-plates and forming the first edge,
a shaft fitted on the body and extending along a longitudinal direction, the clamping part connecting the two flange-plates and forming the first edge,
a cam mounted movable with respect to the clamping part, the cam having a first end defining a ring with a through opening along the longitudinal direction, a second end mechanically the cam to the body by means of a shaft and an arm connecting the first and second ends, the ring moving at least in rotation around the shaft in a plane perpendicular to the longitudinal direction to move towards or away from the clamping part and to define a first position where the distance between the ring and the clamping part is minimal and a different second position, the ring being closer to the clamping part than to the second edge in the first position,
the through opening forms an attachment opening configurated to receive the the connecting part mechanically connecting the belay device and a user,
wherein the ring extends along the longitudinal direction so as to be located facing the clamping part in a plane perpendicular to the longitudinal direction so as to be able to clamp the rope between the ring and the clamping part, the ring providing a separation between the connecting part and the rope, and wherein the ring is located at a distance from the shaft and from the second end to define a cavity allowing a strand of the rope to be inserted between the ring and the second end and/or the shaft between the two flange-plates so as to enable formation of the rope loop around the ring, the connecting part being separated from the clamping part by the ring.

12. Belay system according to claim 11 wherein a cross-section of the through opening in a plane perpendicular to the longitudinal axis of the shaft and a cross-section of the connecting part are non-circular and complementary to form an anti-rotation system of the connecting part with respect to the through opening.

13. Belay system according to claim 11 wherein the connecting part has a cross-section representing at least 75% of the cross-section of the through opening, the cross-section being measured in a plane perpendicular to the longitudinal axis of the shaft.

14. Belay system according to claim 11 wherein the shaft or the second end demarcates a second inlet of the though cavity so that the shaft is designed to press on the tensioned rope strand.

15. Method for using a belay system comprising:
providing a belay system according to claim 11, a rope loop passing though the through cavity and surrounding the ring, a part of the rope separating the ring and the clamping part, another part of the rope separating the ring and the second end,
tensioning the rope, the rope being clamped between the first end and the clamping part,
applying a stress on the body to rotate the body with respect to the ring and increase a distance between the ring and the clamping part.
